(19) United States
(12) Patent Application Publication
(10) Pub. No.: US 2012/0043006 A1
(43) Pub. Date: Feb. 23, 2012

(54) METHOD OF PRODUCING A RESIN-IMPREGNATED FIBER TUBE AND METHOD OF INTERNALLY LINING CONDUITS AND PIPES

(75) Inventor: CHRISTIAN NOLL, LIMBURGERHOF (DE)

(73) Assignee: BRANDENBURGER PATENTVERWERTUNG GDBR, LANDAU (DE)

(21) Appl. No.: 13/285,527

(22) Filed: Oct. 31, 2011

Related U.S. Application Data
(62) Division of application No. 11/811,429, filed on Jun. 8, 2007.
Application No. 11/811,429 is a continuation of application No. PCT/EP2005/012792, filed on Dec. 1, 2005.

(30) Foreign Application Priority Data
Dec. 10, 2004 (DE) 10 2004 059 883.5

(51) Int. Cl. B32B 37/02; B32B 38/08; B32B 37/14

(52) U.S. Cl. 156/62.2; 156/191

(57) ABSTRACT

A method for remediating conduits and pipework includes the production of a resin-saturated fibrous tube for lining the conduits or pipework by impregnating a prefabricated fibrous tube or a tape with a liquid resin. The resin is a solution of an unsaturated polyester or of a vinyl ester in styrene and/or an acrylic ester, the viscosity of the resin being raised after the impregnating. Impregnating is performed by pulling the fibrous tube through a bath of the resin, or in that the resin is blade coated or sprayed onto the fibrous tube, and in that the liquid resin during the impregnating has a viscosity in the range from 200 to 20 000 mPa s and, after the impregnating, is thickened such that its viscosity is in the range from 50 000 to 2 000 000 mPa s. Alternatively, a fibrous tape is first impregnated and then wound into a tubular shape on a mandril.

### CROSS-REFERENCE TO RELATED APPLICATIONS

This is a divisional application of application Ser. No. 11/811,429, filed Jun. 8, 2007; which was a continuing application, under 35 U.S.C. §120, of International application PCT/EP2005/012792, filed Dec. 1, 2005; the application also claims the priority, under 35 U.S.C. §119, of German patent application No. DE 10 2004 059 883.5, filed Dec. 10, 2004; the prior applications are herewith incorporated by reference in their entirety.

### BACKGROUND OF THE INVENTION

### Field of the Invention

The invention pertains to a method for producing a resin-saturated fibrous tube for lining conduits and pipework by impregnating a fibrous tube or a fibrous tape with a liquid resin. Specifically, the invention pertains to a method for refurbishing and rehabilitating sewer conduits, pipes, and the like by lining with resin-saturated fiber-reinforced liners.

A particularly elegant way to remediate buried wastewater conduits, water lines and similar pipe systems consists in a flexible fibrous tube impregnated with liquid resin being introduced into the pipe and inflated there and thereafter the resin being cured. The problem with this is that the liquid resin can drain from the fibrous tube after impregnation or at least accumulate on the bottom side of the tube.

It is therefore proposed in European patent No. EP 799 397 to impregnate a three-ply glass fiber tube having an inner ply of a bulky fibrous mat and two outer plies of a woven roving fabric with a low-viscosity liquid resin and to gel an outer layer by UV irradiation. The production of a three-ply fibrous tube is of course costly and inconvenient, and it is also possible for the resin in the bulky inner ply to settle out in the downward direction during storage, resulting in a nonuniform impregnation.

The same reference also describes an alternative procedure whereby the viscosity of the resin can be increased by means of thixotroping or thickening agents after the impregnating step to prevent leakage. But this approach is called disadvantageous since, it is stated, the rate of impregnation would be appreciably decelerated and wetting of the individual fibers would be incomplete. In addition, it is stated, that when the impregnated tube is wound up or folded the resin becomes squeezed out in the fold regions.

### SUMMARY OF THE INVENTION

It is accordingly an object of the invention to provide a method of refurbishing pipework and the like by producing resin-saturated tube which overcomes the above-mentioned disadvantages of the heretofore-known devices and methods of this general type and which provides for a simple process for producing a resin-saturated fibrous tube and for lining a pipe or conduit structure with the tube.

With the foregoing and other objects in view there is provided, in accordance with the invention, a method of lining a tubular structure, which comprises:

producing a resin-saturated fibrous tube by:
fabricating a fibrous tube;
providing a liquid resin in the form of a solution of an unsaturated polyester or a vinyl ester in styrene and/or an acrylic ester;
impregnating the fibrous tube with the liquid resin by pulling the fibrous tube through a bath of the resin, or blade-coating the resin onto the fibrous tube, or spraying the resin onto the fibrous tube;
setting a viscosity of the resin during the impregnating step to a viscosity in a range from 200 to 20 000 mPa s; and
subsequently thickening the resin by raising the viscosity of the resin to a range from 50 000 to 2 000 000 mPa s; and

subsequently lining the tubular structure with the resin-saturated fibrous tube.

In an alternative embodiment of the invention, a fibrous tape is first impregnated and wound onto a mandrel to form a fibrous tube.

In other words, the objects of the invention are achieved according to the present invention when both the initial resin and the thickened resin are adjusted to optimum viscosity.

The present invention accordingly provides a process for producing a resin-saturated fibrous tube for lining conduits and pipework by impregnating a fibrous tape with a liquid resin and winding the fibrous tape around a mandrel, or by impregnating a prefabricated fibrous tube with a liquid resin, wherein the liquid resin during the impregnating has viscosity in the range from 200 to 20 000 mPa s and, after the impregnating, is thickened such that its viscosity is in the range from 50 000 to 2 000 000 mPa s.

Fibrous tape and fibrous tube will hereinafter be known together as “fibrous structure”. This fibrous structure can be for example a woven fabric, a laid fabric, a mat, a needle-punched nonwoven web, a fleece, or a felt, or combinations thereof, and consist of glass fibers or synthetic fibers.

The liquid resin can be a solution of an unsaturated polyester or of a vinyl ester in styrene and/or an acrylic ester.

Other features which are considered as characteristic for the invention are set forth in the appended claims.

Although the invention is illustrated and described herein as embodied in production of a resin-impregnated fiber tube for internally lining conduits and pipes, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the examples described herein.

### DETAILED DESCRIPTION OF THE INVENTION

In a preferred embodiment, the fibrous structure consists of a woven glass fiber fabric or a glass fiber mat or a combinations thereof. In this case, a chemical thickening agent is used, preferably an oxide or hydroxide of magnesium or calcium, for example LUVATOL from Lehmann & Voss & Co. of Germany, preferably in amounts of 0.2 to 5% by weight and in particular of 0.3 to 1% by weight of solids, based on the resin. The thickening agent can either be used as a pulverulent solid or as a paste dispersed in a liquid vehicle. The thickening agent is stirred into the resin shortly before the impregnating.

The impregnating is preferably accomplished by pulling the fibrous structure slowly through a bath filled with the liquid resin adjusted to the “right” viscosity, or by blade coating or spraying the resin onto the fibrous structure or applying the resin to the fibrous structure as a liquid film. Thereafter, the resin is allowed to thicken by allowing the impregnated fibrous structure to stand for a prolonged period, preferably at least one day, in particular several days, at room temperature or heating it to temperatures of not more than 80° C. for several hours.

In another embodiment, the fibrous structure is a polyester fiber felt. Since felt is very dense, the thickening agent can be dispensed with here and, in order to raise the viscosity, it is sufficient to thicken with a thixotroping agent, for example WACKER HDK from Wacker-Chemie of Germany or AEROSIL from Degussa of Germany which are physical thickening agents and act by hydrogen bonding.

The primarily important feature of the present invention is the optimum relationship between the viscosities during and after the impregnation. During the impregnating, it is a feature of the present invention that the viscosity shall be between 200 and 20 000 mPa s. If the viscosity is too low, the resin solution will separate in the fibrous structure; if the viscosity is too high, impregnation of the fibrous structure will be insufficient.

The viscosity depends on the identity of resin and on the temperature during the impregnating step, and it can be specifically adjusted for example through the choice of polyester or vinyl ester and the concentration of the resin solution. The higher the temperature of the bath during the impregnating step, the lower the viscosity. Impregnating is preferably carried out between 15 and 30° C.

After the impregnating, it is a feature of the present invention that the viscosity shall rise to 50 000-2 000 000 mPa s. If the viscosity is too low here, then the resin will be squeezed out of the fibrous tube when the impregnated fibrous tube is being inflated in the pipework; if the viscosity is too high, then the flowability of the resin in the impregnated fibrous tube is too low, so that voids and surface defects arise in the resin as it cures. The optimum final viscosity can be set in a specific manner through the choice of the type and amount of thickening agent.

In one version of the preferred embodiment, the initial resin is a thin liquid and is admixed with a thixotroping agent, preferably in amounts of 0.5% to 5% by weight, based on the resin. Following addition of the thixotroping agent, the viscosity rises very rapidly to the preferred impregnating viscosity of 1000 to 10 000 mPa s, in particular of 2000 to 8000 mPa s. After the impregnating step, the action of the chemical thickening agent is used to thicken to the preferred final viscosity of 100 000 to 1 000 000 mPa s and in particular of 200 000 to 800 000 mPa s.

In the alternative embodiment involving the use of a physical thickener, the preferred final viscosity is in the range from 50 000 to 200 000 mPa s. The final viscosity can likewise be set via the type and amount of thixotroping agent.

The optimum type and amount of thickening agent and of thixotroping agent is simple to determine in preliminary experiments.

The liquid resin used is preferably a photocurable resin. This photocurable resin contains a photoinitiator as described, for example, in U.S. Pat. No. 4,425,287 and in European patent No. EP 0 023 634 B1. That specification, which is herein incorporated by reference, also contains further details concerning liquid resins and thickening agents and also the thickening and curing of the resins with UV light.

Another embodiment utilizes a free-radically curable liquid resin, which contains a peroxide initiator. In this case, curing takes place by raising the temperature to above the disintegration temperature of the peroxide or, in the case of cold-curing resins, through addition of an accelerant.

The process of the present invention can proceed either from a fibrous tape, which is impregnated, thickened and wound about a mandrel to form a fibrous tube as described in the commonly assigned U.S. Pat. No. 5,798,013 and European patent EP 0 712 352 B1 for example, and which are also incorporated by reference. Alternatively, it is also possible to proceed from a ready-produced fibrous tube, which is directly impregnated and thickened. The impregnated fibrous tube can be provided with films on the inside and the outside and stored.

To line sewers, pipework, and conduits, and the like—herein referred to, in general, as a tubular structure—the fibrous tube is drawn into the structure to be lined and inflated there, so that it conforms to the inner surface and the resin is cured either by UV irradiation or free-radically through increased temperature, for example with hot water.

1. A method of lining a tubular structure, which comprises:
producing a resin-saturated fibrous tube by:
fabricating a fibrous tube from glass fibers,
providing a liquid resin in the form of a solution of an unsaturated polyester or a vinyl ester in styrene and/or an acrylic ester,
impregnating the fibrous tube with the liquid resin by pulling the fibrous tube through a bath of the resin, or blade-coating the resin onto the fibrous tube, or spraying the resin onto the fibrous tube,
setting a viscosity of the resin during the impregnating step to a viscosity in a range from 1000 to 10,000 mPa s, and
after the impregnating, utilizing a thickening agent to thicken to a final viscosity in a range from 100,000 to 1,000,000 mPa s, the thickening agent being an oxide or hydroxide of magnesium or calcium; and
subsequently lining the tubular structure with the resin-saturated fibrous tube.

2. The method according to claim 1, wherein the fibrous tube consists of a woven fabric, a laid fabric, a mat, a fleece, a needle-punched non-woven web, or a felt, or combinations thereof, of glass fibers or synthetic fibers.

3. The method according to claim 1, wherein the resin contains 0.2% to 5% by weight of the thickening agent in pulverulent solid form or in form of a paste dispersed in a liquid vehicle.

4. The method according to claim 1, which comprises thickening the resin by storing the impregnated fibrous tube for multiple days substantially at room temperature.

5. The method according to claim 1, which comprises thickening the resin by heating the impregnated fibrous tube for multiple hours.

6. The method according to claim 1, wherein the fibrous tube is formed of a felt of polyester fibers and the resin contains a thixotroping agent for thickening.

7. The method according to claim 6, wherein the thixotroping agent is fumed silica.

8. The method according to claim 1, wherein the liquid resin is a photocurable resin containing a photoinitiator.

9. The method according to claim 1, wherein the liquid resin is a free-radically curable resin containing a peroxide initiator.

10. A method of lining a tubular structure, which comprises:
producing a resin-saturated fibrous tube by:
providing a fibrous tape,
providing a liquid resin in the form of a solution of an unsaturated polyester or a vinyl ester in styrene and/or an acrylic ester,
admixing a thixotroping agent to the liquid resin when the liquid resin is in a thin liquid state to set an impregnating viscosity to a range of 1,000 to 10,000 mPa s and then impregnating the fibrous tape with the liquid resin by pulling the fibrous tape through a bath of the resin, or blade-coating the resin onto the fibrous tube, or spraying the resin onto the fibrous tape,
after the impregnating step, raising the viscosity of the resin by utilizing a thickening agent to thicken the resin to a final viscosity in a range from 100,000 to 1,000,000 mPa s,
after performing the step of raising the viscosity of the resin to the range from 100,000 to 1,000,000 mPa s, winding the fibrous tape around a mandrel to form the resin-saturated fibrous tube; and
drawing the resin-saturated fibrous tube into the tubular structure such that the fibrous tube conforms to an inner surface of the tubular structure, and subsequently curing the resin by UV irradiation or free-radically by increasing a temperature of the resin;
wherein the fibrous tape includes glass fibers and the thickening agent includes an oxide or hydroxide of magnesium or calcium.

11. The method according to claim 10, wherein the fibrous tape consists of a woven fabric, a laid fabric, a mat, a fleece, a needle-punched non-woven web, or a felt, or combinations thereof, of glass fibers or synthetic fibers.

12. The method according to claim 10, wherein the resin contains 0.2% to 5% by weight of the thickening agent in pulverulent solid form or in form of a paste dispersed in a liquid vehicle.

13. The method according to claim 10, which comprises thickening the resin by storing the impregnated fibrous tube for multiple days substantially at room temperature.

14. The method according to claim 10, which comprises thickening the resin by heating the impregnated fibrous tube for multiple hours.

15. The method according to claim 10, wherein the fibrous tube is formed of a felt of polyester fibers.

16. The method according to claim 15, wherein the thixotroping agent is fumed silica.

17. The method according to claim 10, wherein the liquid resin is a photocurable resin containing a photoinitiator.

18. The method according to claim 10, which comprises storing the fibrous tube before performing the step of drawing the fibrous tube into the tubular structure.
